(19) United States
(12) Patent Application Publication
(10) Pub. No.: US 2009/0015740 A1
(43) Pub. Date: Jan. 15, 2009

(54) WINDOW DARKENING SYSTEM

(76) Inventors: Ravil Sagitov, Staten Island, NY (US); Marina Meliton, Staten Island, NY (US)

Correspondence Address: NW-IP-LAW, 6039 E. Grant RD., Tucson, AZ, 85712, US

(21) Appl. No.: 11/777,158

(22) Filed: Jul. 12, 2007

(51) Int. Cl. G02F 1/1333; G02F 1/133

(52) U.S. Cl. 349/16

(57) ABSTRACT

A window darkening system that includes glass panels. Glass panels can be provided in the form of at least one side window, a windshield, and rear window. Glass panels include electrically activated liquid crystals embedded therein. A control module includes access to a power source, and a user interface provided to manipulate liquid crystals embedded within the glass panels. The liquid crystals are sandwiched between a pair of electrodes which are electrically connected to the power source via the control panel via at least one switch means. The crystals become activated and darken the windowpane when they are electrically connected to a power source via activation their activation at user interface.

### FIELD OF THE INVENTION

The present invention is directed to an automobile window darkening system.

### BACKGROUND OF THE INVENTION

Automobile windows can be tinted to shield the passengers and/or the automobile's interior from unwanted exterior light. Conventional window tinting typically relates to adhesively applying a tinted, transparent layer to each window. However, tinted windows entail a permanent darkening of the windows and may impair the vision of the driver at night. Furthermore, the adhesively applied tint will eventually show wear or scratching with use, which is also impairment to the driver.

There are window systems where the windows may be darkened upon command. See, for example, U.S. Pat. No. 6,580,472, the specification of which is incorporated in its entirety herein by reference. However, those window systems are restrictive and do not allow for the operator to personalize the shading area of the window.

Therefore, there is a need for an improved window darkener system, where the operator has more control over the area of the window to be shaded.

### SUMMARY OF THE INVENTION

In accordance with features of the present invention, a window darkening system is provided that includes glass panels. Glass panels can be provided in the form of at least one side window, a windshield, and rear window. Glass panels are provided with liquid crystals embedded therein. A control module including access to a power source and a user interface are provided to manipulate liquid crystals embedded within the glass panels selectively and independently. The liquid crystals are sandwiched between a pair of electrodes which are electrically connected to the power source via the control panel via at least one switch means, e.g., on-off switch, variable switch, etc. The crystals become activated and darken the windowpane, i.e., glass panel, when they are electrically connected to a power source via activation at user interface.

In some embodiments, the window darkening system comprises a glass panel which further comprises multiple panel sections. Each panel section comprises a layer of liquid crystals sandwiched therein, and the layer of liquid crystals is electronically linked to a pair of electrodes. The control module includes access to a power source, and further comprises a user interface including at least one switch means. Said control module is provided to selectively and independently manipulate a layer of liquid crystals sandwiched within the panel section. The layer of liquid crystals is electrically connected to the power source by the control panel via a switch means and wherein the liquid crystals become activated and darken the panel section of the glass panel when they are electrically connected to a power source, wherein a selected region of the glass panel is darkened based on a particular layer of liquid crystals in a particular panel section being activated.

In some embodiments, the user interface comprises a touch screen. In some embodiments, the user interface comprises a touch screen showing a picture of a glass panel, wherein the glass panel corresponding to the picture of the glass panel on the touch screen darkens at a region that is touched by an operator on the picture of the glass panel on the touch screen.

In some embodiments, the panel section comprises three panel sub-sections, wherein the glass panel associated with the first panel sub-section is tinted red, the glass panel associated with the second panel sub-section is tinted green, and the glass panel associated with the third panel sub-section is tinted blue, a layer of liquid crystal embedded within each panel sub-section is independently activated to allow for various ratios of red light, green light, and blue light to pass through each sub panel.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

FIG. 1A illustrates a top view of an automobile incorporating aspects of the present invention to control the darkening of glass windows (glass panels) associated with the automobile;

FIG. 1B illustrates a top view of an automobile incorporating aspects of the present invention to control the darkening of glass panels associated with the automobile, wherein a switch means (e.g., a variable selector) is located near or on every glass panel;

FIG. 2A illustrates system components for controlling the darkening of glass panels using a switch means (e.g., on-off switch), in accordance with features of the invention. The illustrative glass panel comprises a panel section, wherein each panel section comprises a layer of liquid crystal sandwiched therein;

FIG. 2B illustrates system components for controlling the darkening of glass panel sections using a switch means, e.g., a variable switch, in accordance with features of the invention;

FIG. 3A illustrates system components for controlling the darkening of multiple panel sections formed along glass panels using a switch means, e.g, an on-off switch, in accordance with features of the invention;

FIG. 3B illustrates system components for controlling the darkening of multiple panel sections formed along glass panels using a switch means, e.g., a variable switch, in accordance with features of the invention;

FIGS. 4A-F illustrate various configurations of glass incorporating aspects of the present invention for causing the variable darkening of glass panel sections incorporated along glass panels associated with automobiles;

FIG. 5A illustrates horizontally configured panel sections formed along glass panels including LCD technology connected to a power source through a switch means, e.g., a variable selector switch, in accordance with aspects of the present invention;

FIG. 5B illustrates diagonally configured panel sections formed along a glass panel including LCD technology connected to a power source through a switch means, e.g., a variable selector switch, in accordance with aspects of the present invention;

FIG. 6A illustrates a block diagram of system components for a user interface in the form of a touch sensitive controller that can be utilized to carry out aspects of the present invention;

FIGS. 6B and 6C illustrate an exemplary diagram of a touch sensitive screen operated by a user to darken one panel section of a glass panel; and

FIG. 7 illustrates a block diagram of glass in accordance with features of the present invention wherein panel sections of the glass can be configured to manage or operate with certain colors.

FIG. 8 illustrates that the word “Just Married” is formed by the darkening of the individually selected panel sections 2.

### DESCRIPTION OF PREFERRED EMBODIMENTS

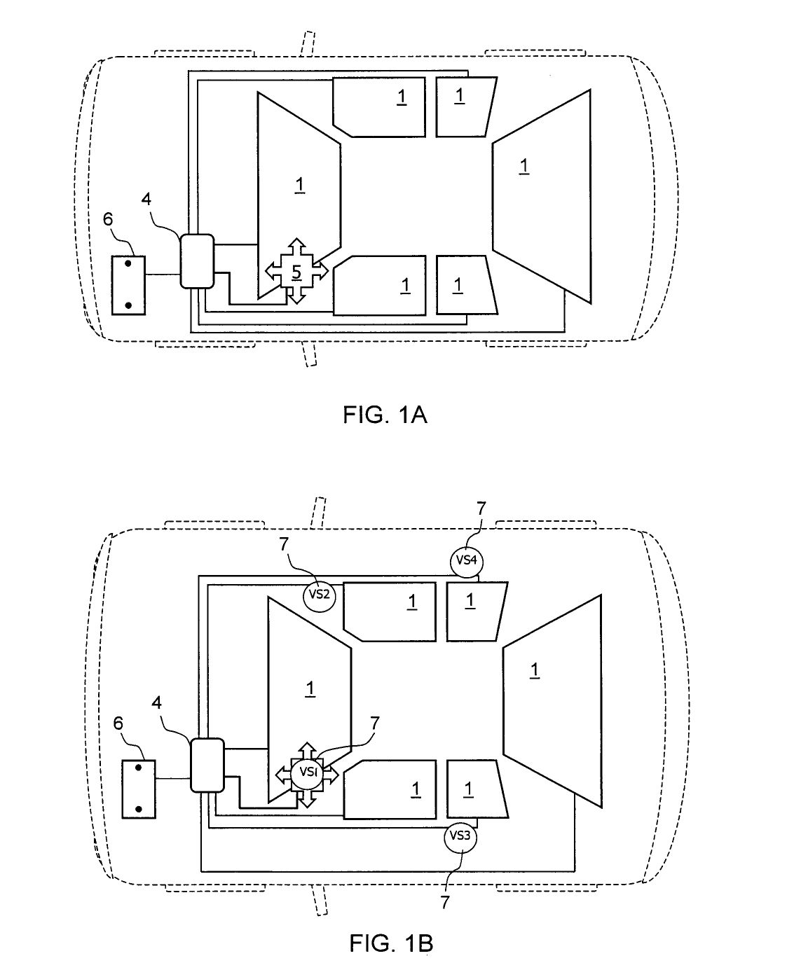

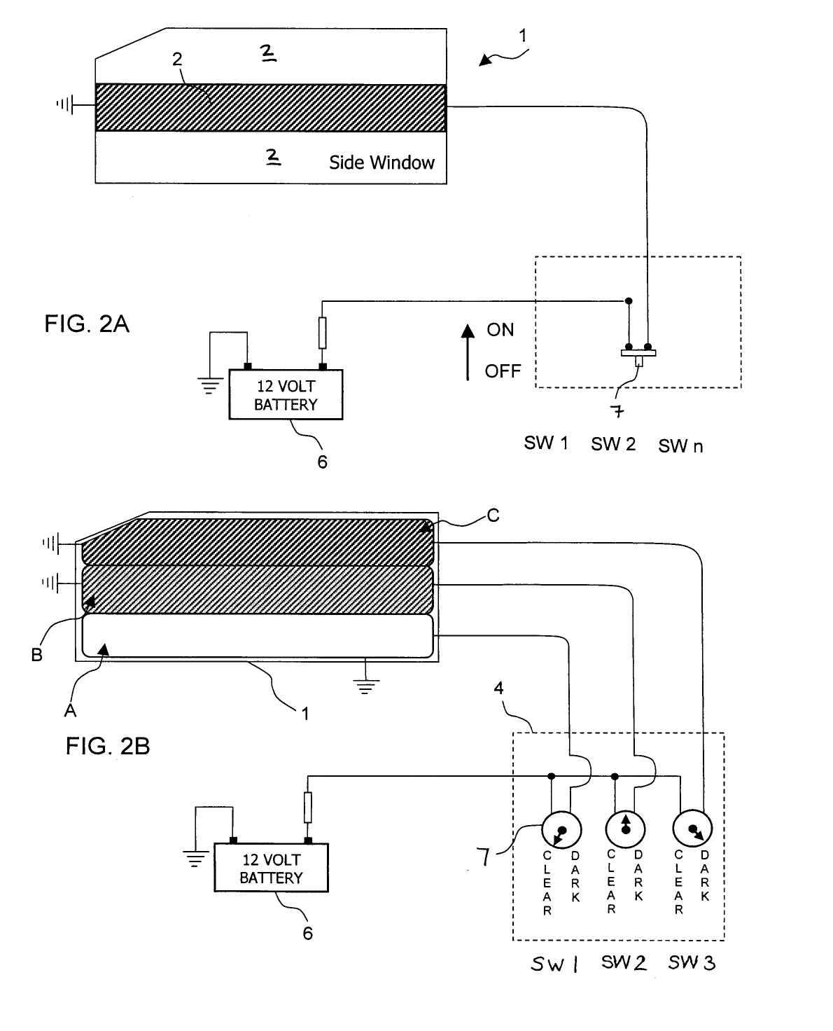

Referring now to FIGS. 1, 2A and 2B, the present invention relates to a window darkening system. An automobile typically includes two or more side windows, a windshield, and a rear window, referred to herein as a glass panel 1. The window darkening system according to the present invention includes glass panels 1 in the form of at least one side window, a windshield, and rear window with liquid crystals embedded therein, a control module 4 including access to a power source 6, and a user interface 5. In some embodiments, the control module 4 includes at least one microprocessor 15. The control module 4 can activate selectively and independently at least one layer of liquid crystals in the panel section 2 to darken the panel section. In its simplest form, which is shown in FIG. 2A, liquid crystals are embedded within at least one panel section 2 of each a glass panel 1. In some embodiments, the glass panel 1 comprises a plurality of panel sections 2, wherein each panel section comprises at least one layer of crystals sandwich therein. The liquid crystals are sandwiched between a pair of electrodes which are electrically connected to the power source 6, such as the automobile battery, via at least one user interface 5, which includes a switch means 7. When the crystals are electrically connected to a power source 6 via activation at user interface 5, they become activated and darken at least one panel section 2 of a glass panel 1.

In general embodiments, to use the above-described device, a user activates the switch means 7 corresponding to the glass panel 1 that he or she wishes to tint. Upon activation of the switch means 7, an electrical current is delivered to the liquid crystals embedded within the glass panel 1 thereby causing the molecular structure thereof to change. Accordingly, the degree of transparency of the selected windowpane will be altered. If the user wishes to remove the tinting, the appropriate switch means 7 is disabled whereby electric current to the crystals is removed and the crystals return to their original state.

Some embodiments enable crystals within each glass panel 1 to be independently tinted with separate switch means 7 as shown in FIG. 1B. The user interface 5, which can operate as a master controller for all windows, can be provided in the form of at least one switch means 7, and is preferably disposed in an easily accessible location within the passenger compartment closest to the driver. The additional switch means 7 should ideally be located closest to windows located near and associated with each passenger location. Switch means 7 are ideally variable selector switches in order to enable a range of darkening/lightening control to users.

The windows of the present invention may be constructed similar to an LCD (liquid crystal display). For example, with polarized glass, a special polymer that creates microscopic grooves in the surface is rubbed on the side of the glass that does not have the polarizing film on it. The grooves must be in the same direction as the polarizing film. Then add a coating of liquid crystals, e.g., nematic liquid crystals, to one of the filters. The grooves will cause the first layer of molecules to align with the filter's orientation. Then add the second piece of glass with the polarizing film at a right angle to the first piece. Each successive layer of molecules will gradually twist until the uppermost layer is at a 90-degree angle to the bottom, matching the polarized glass filters. When light strikes the first filter, it is polarized. The molecules in each layer then guide the light they receive to the next layer. As the light passes through the liquid crystal panel sections, the molecules also change the light's plane of vibration to match their own angle. When the light reaches the far side of the liquid crystal substance, it vibrates at the same angle as the final layer of molecules. If the final layer is matched up with the second polarized glass filter, then the light will pass through.

In accordance with features of the present invention, as an electric charge is applied to liquid crystal molecules, they untwist. When they straighten out, they change the angle of the light passing through them so that it no longer matches the angle of the top polarizing filter. Consequently, little or no light can pass through that area of the liquid crystal, which makes that area darker than the surrounding areas.

As shown in FIG. 2B, independent switch means 7 in the user interface 5 can be provided in the form of variable switches, which enable the darkness of each glass panel 1, or panel section 2, to be adjusted. The glass panel 1 shown in FIG. 2B is shown with three distinct panel sections of independently adjustable crystals. Panel section 1 (“A”) is shown with no darkening, which is also shown at the variable switch SW1 setting. Panel section 1 (“B”) is shown with mid-range darkening, also shown at mid-range on the associated variable switch SW2 setting. Panel section 1 (“C”) is shown at the darkest setting, which is also indicated by its associated switch SW3 setting.

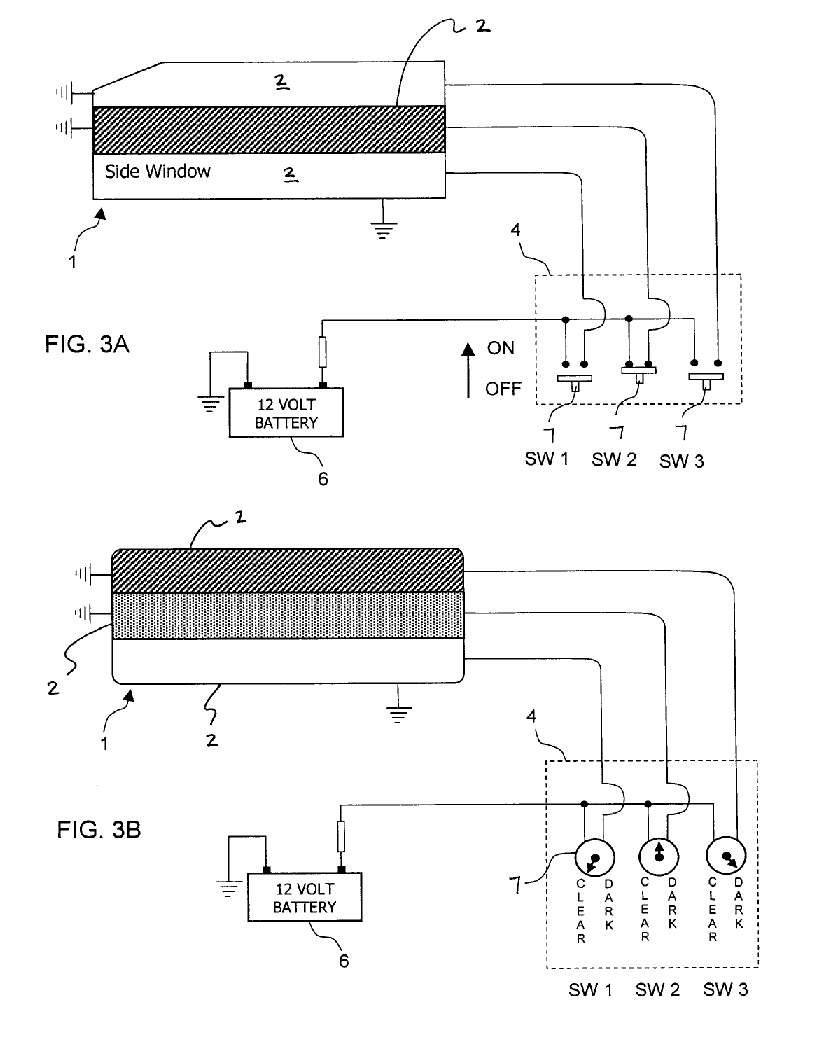

Now referring to FIG. 3A, an exemplary embodiment is illustrated wherein a window darkening system comprised of a multiple of panel sections 1 associated with a single glass panel 1, which can be controlled using a control panel 4 to vary the darkness of each panel section 2 of the glass panel 1. In this embodiment, three switch means 7 in the user interface 5 are shown electrically tied to a dedicated panel section 2 containing the liquid crystal. In FIG. 3A, only one switch means 7 (SW2) is on causing the middle panel section 2 to become darkened, while the other switch means 7 (SW1 and SW3) are off resulting in not darkening of their respective panel sections 2. Referring to FIG. 3B, another exemplary embodiment is illustrated wherein a switch means 7, e.g., a variable switch, of the user interface 5 are used to control each panel section 2 of the panel 1. SW1 is shown in the clear (i.e. “off”) position, resulting in no darkening of its panel section 2. SW2 is shown at mid-range, resulting in intermediate darkening of its panel section 2. Finally, SW3 is shown at fully dark setting, resulting in complete darkening of its respective panel section 2.

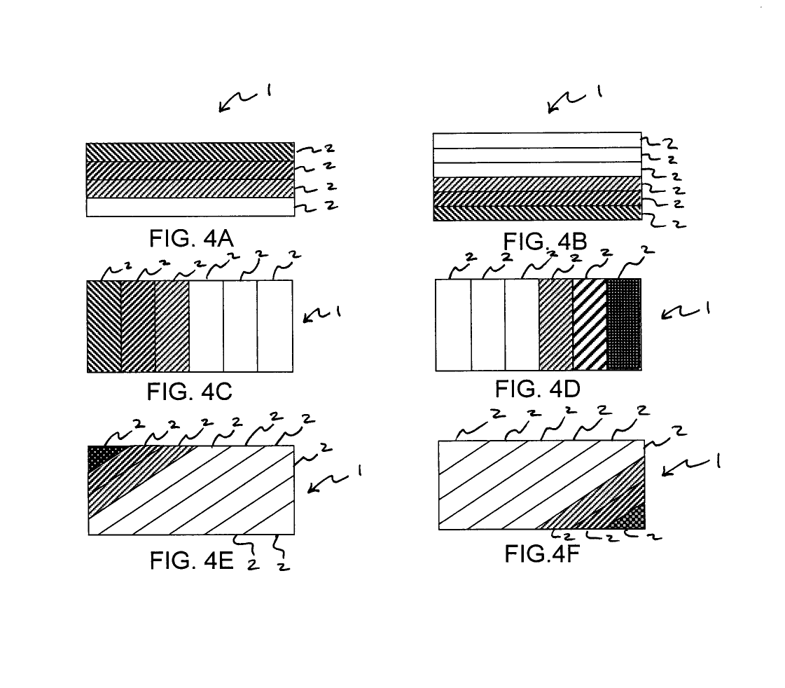

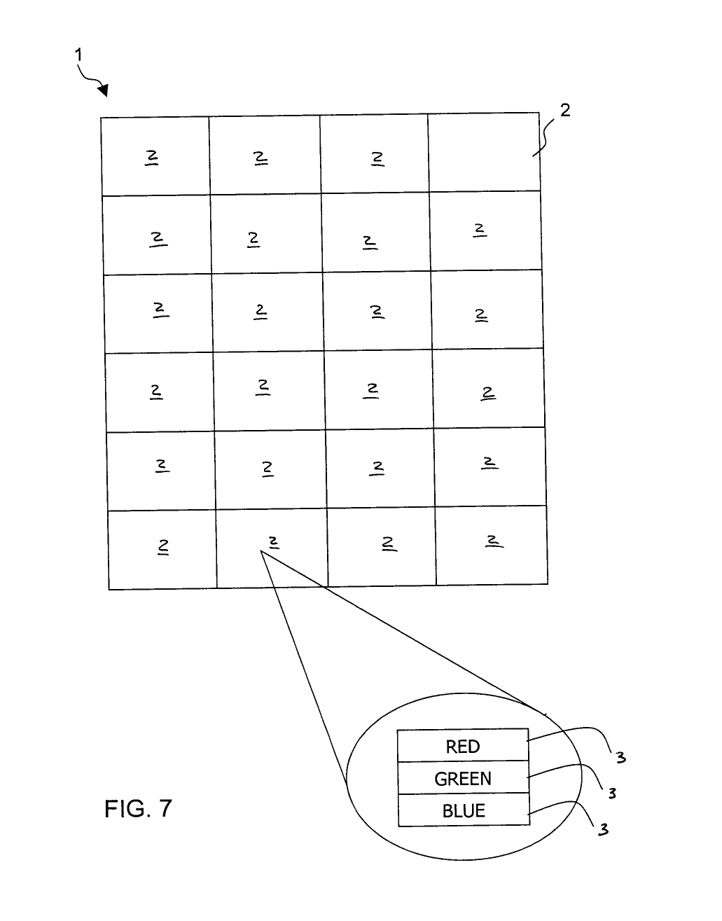

Referring to FIGS. 4A through 4F, various gradients of darkening are shown for glass panels 1 with multiple panel sections 2. A panel section 2 may be shaped in a form of a strip as shown in FIGS. 4A through 4F. In some embodiments, a panel sub-section 2 may be shaped in a form of a square or rectangular shape. In some embodiments, two or more sides of a panel sub-section 2 is in contact with a side of another panel sub-section 2 (see, for example, FIG. 7). FIG. 4A illustrates a typical, horizontally darkened glass panel with only the upper panel section 2 fully darkened. Such a glass panel 1 may ideally be used in a windshield deployment, wherein only a sun visor band of extreme darkening is preferred by the driver or allowed by law for windshields. FIG. 4B illustrates another horizontally darkened glass panel 1 with only its lower panel sections 2 progressively darkened on the glass panel 2. FIG. 4C illustrates a glass panel 1 with vertically configured panel sections 2, wherein the panel sections 2 are progressively darkened from left to right. In FIG. 4D, panel sections 2 on the glass panel 1 are progressively darkened from right to left. FIGS. 4E and 4F illustrate glass panel 1 with diagonally configured panel sections 2, wherein various panel sections 2 are activated to provide various darkening states along each layer moving diagonally upward or downward. Given the illustrations of FIGS. 4A-4F, it can be appreciated that each panel section of a glass panel can be activated independently and variably to provide a desired effect within a vehicle compartment. It should be appreciated now that activation of all panel sections would result in the darkest effect.

Constructing a glass panel 1 with a plurality of defined liquid crystal panel sections embedded therein can provide additional benefits. Panel sections can be arranged to form a selective darkening, e.g., darker at the top and lighter at the bottom, darker in the left and lighter to the right, etc. In some embodiments, each glass panel has at least two panel sections that can be darkened independently and variably. It can be appreciated that each window can have 3-6, or even 7-10, or more, panel sections; however, substantial darkening and cost of manufacture would result with this redundancy and would be ideal for limited specialized applications. The skilled can appreciate that at least two panel sections are possible given the teaching herein.

The panel sections 2 may also be of any shape, e.g., square, circle, oval. Further, the panel sections 2 may or may not span the entire length or height of a window. Panel sections 2 can be arranged to form a selective darkening, e.g., darker at the top and lighter at the bottom, darker in the front and lighter in the back, etc. Each window can have at least two panel sections 2, although more than two panel sections (e.g., 3-6 panel sections, 7-10 panel sections, etc.) are possible. However, it can be appreciated that each window can have about 7-10, or more, panel sections; however, substantial darkening and cost of manufacture would result with this redundancy and would be ideal for limited specialized applications.

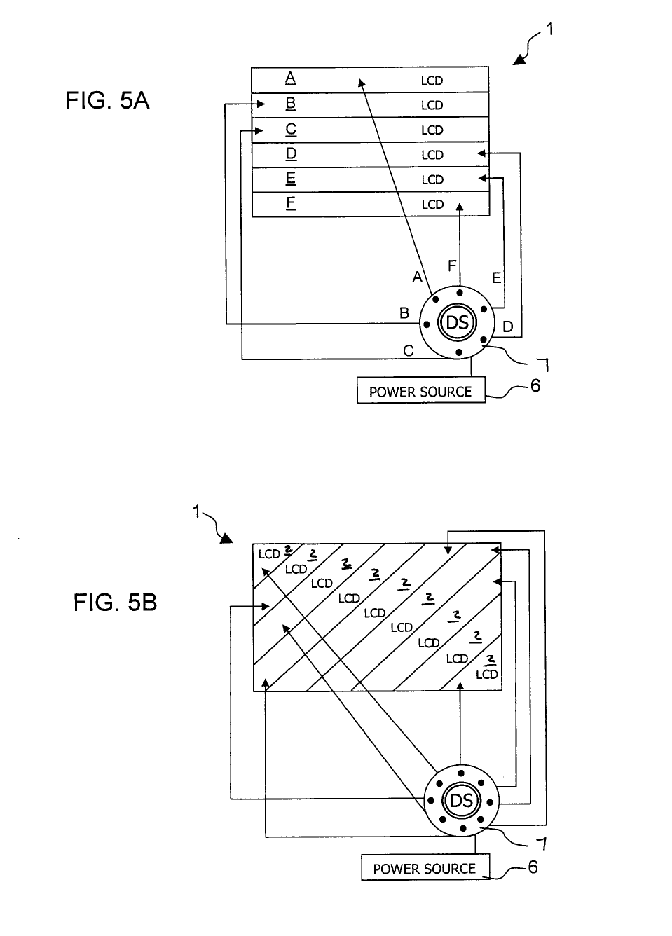

Referring to FIGS. 5A and 5B, another embodiment of the invention is illustrated wherein various panel sections 2 of a glass panel 1 can be activated by a switch means 7, e.g., a selector switch, providing electrical connection to each layer with a power source 6. FIG. 5A illustrates an exemplary horizontal or vertical layer configuration for the glass panel, while FIG. 5B illustrates a diagonal configuration. In the exemplary horizontal configuration, each panel section 2 (e.g., A-F) is independently activated by an associated setting A-F on the switch means 7, e.g, a selector switch. In the exemplary “diagonal” configuration, there are, for example, 8 liquid crystal panel sections 2 (the exemplary 8 liquid crystal panel sections are not limiting—any practical number of panel section is considered to be within the scope of this invention). It can be darkened from right to left or left to right. In the exemplary “horizontal” (or vertical) configuration, there are 6 liquid crystal panel sections 2. (The exemplary 6 liquid crystal panel sections are not limiting—any practical number of panel section 2 is considered to be within the scope of this invention). Each glass panel 1 can be darkened from top to bottom or bottom to top. Liquid crystal panel sections can be individually controlled by an individual switch means 7 (e.g., dimmer switch, variable switch, etc.) located on each door and/or dashboard.

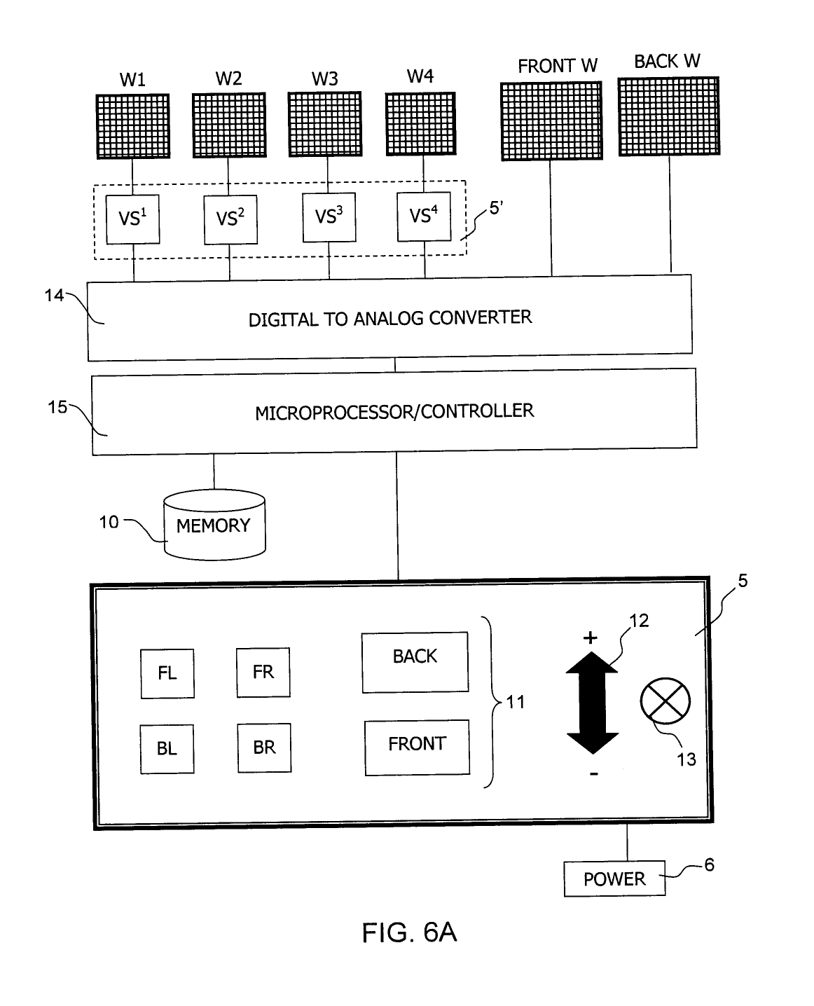

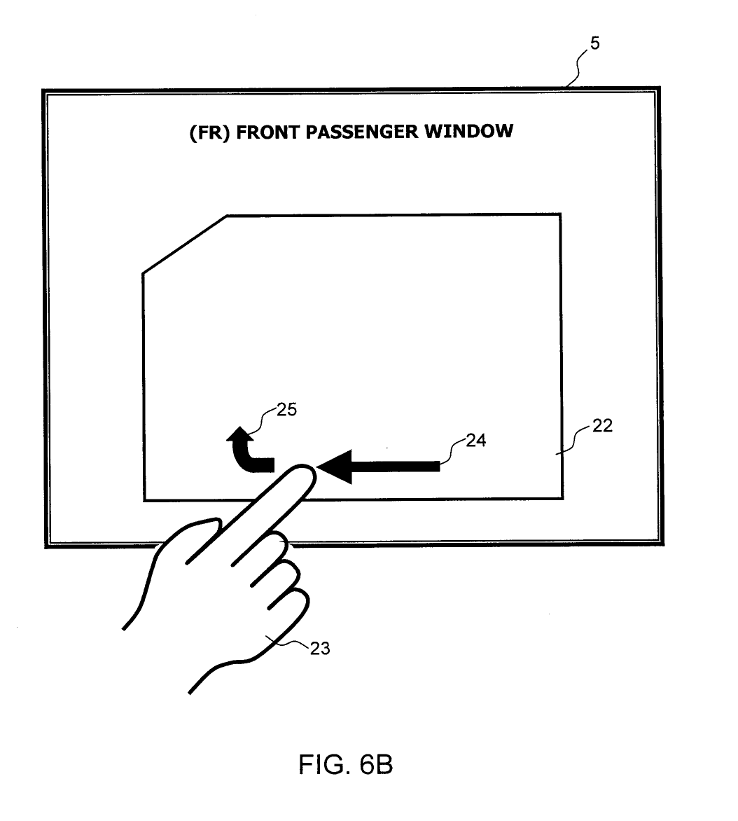

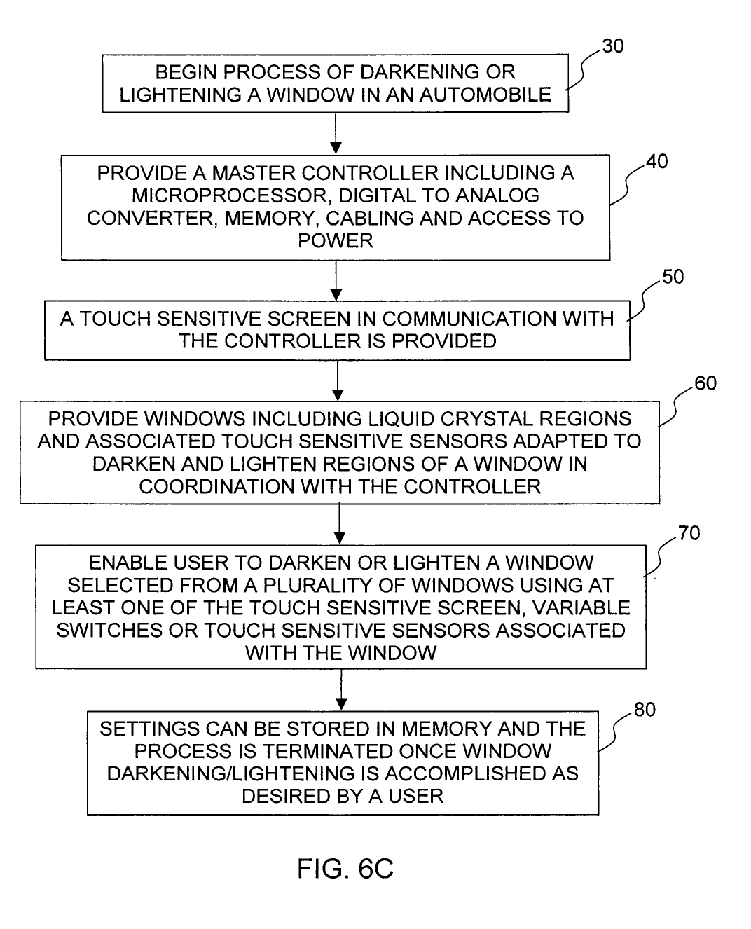

Referring to FIGS. 6A and 6B, a window darkening system can be provided wherein the operator can selectively darken a glass panel 1 by activating a selected glass panel 1 that the operator wants to darken/lighten from a user interface 5 provided in the form of a touch screen. For example, as shown in FIG. 6A, each glass panel 1 of a car can be linked using electronic cabling known in the art to a touch screen 5 via a digital to analog converter 14 under the controller of a microprocessor 15. (W1=window 1 or glass panel 1, W2=window 2 or glass panel 1, W3=window 3 or glass panel 1, W4=window 4 or glass panel 1, FRONT W=front window or glass panel 1, BACK W=back window or glass panel 1, VS¹=variable switch controlling W1, VS²=variable switch controlling W2, VS³=variable switch controlling W3, VS⁴=variable switch controlling W4, broken lines around the VS's means that the variable switch may be optionally linked into the system, discussed below). Software supporting the operation of the system and representative templates for each controllable glass panel 1 can be stored in memory 10. The particular image of a glass panel 22 is shown (FIG. 6B) after an operator selects and touches a particular image of a selecting glass panel 11 (e.g., FL=front left window, FR=front right window, BL=back left window, and BR=back right window) from the touch screen 5 shown in FIG. 6A.

An exemplary touch screen (for FIG. 6B) can work as follows. The image representative of a glass panel 22, retrieved from memory 10, is shown on the touch screen 5. The operator selects a region on the image of the glass panel 22 that he wishes to darken by contacting/sliding a finger over a region on the image of the glass panel 22 to be tinted. The region on the actual glass panel 1 that corresponds with the region on the image of the glass panel 22 comprises one or more panel sections 2 which can be darkened independently and variably (e.g., a panel section may be in the shape of a square or rectangular, see FIG. 7). As shown in FIG. 6B, a larger representation/image of the particular glass panel 22 that the operator wants to manipulate is shown on the screen 5. Panel sections 2 of the glass panel 1 that the operator wants darkened or lightened are controlled as the operator rubs his finger over the touch sensitive screen 5 at the locations of the window icon, i.e., the image of representative of the glass panel 22. The operator can toggle between darkening and lightening of the screen by re-touching the areas that the operator wants to darken/lighten, or by using soft up/down button 12; or turn off the touch screen by pressing on the soft button 13 shown in FIG. 6A.

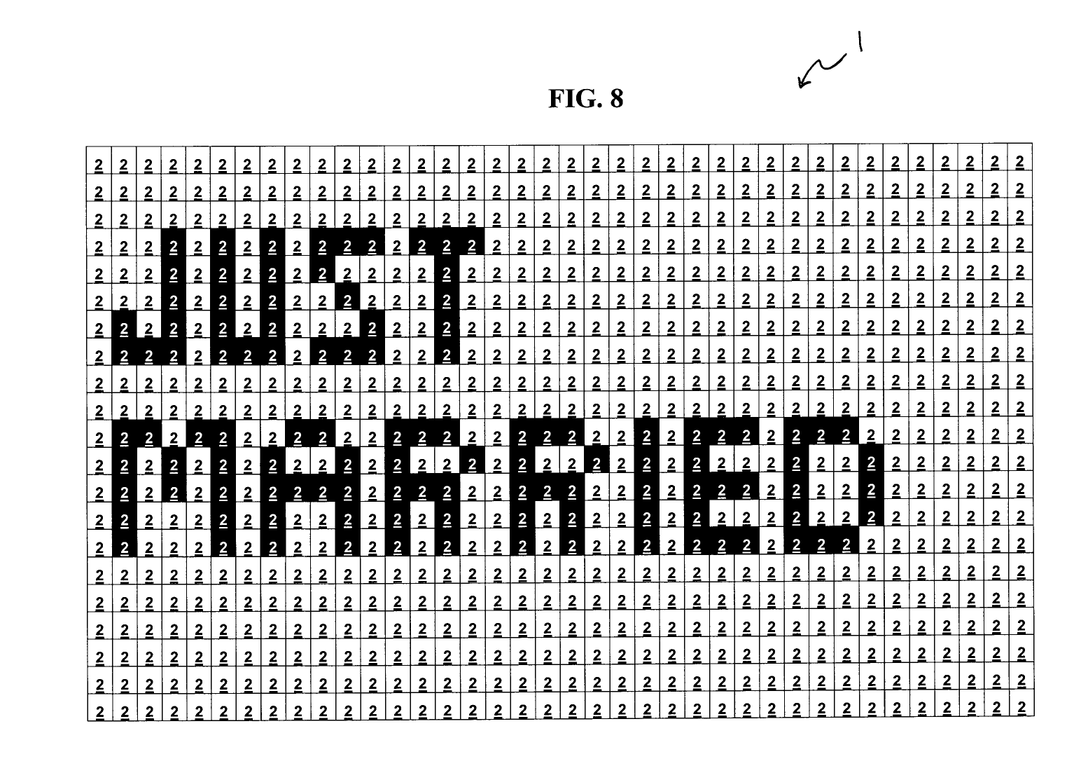

FIG. 6B illustrates a touch screen showing an image representative of a particular glass panel 22. A particular glass panel 1 of a car represented in the touch screen 5 in FIG. 6A can be selected by the operator, by having the operator touching the image of a selecting glass panel 11, e.g., FR, FL, etc. (see FIG. 6A). A larger image of the particular glass panel 22 can be shown on the touch screen 5 as shown in FIG. 6B. In FIG. 6B, an iconic representation of the front right (FR) window (which can be more particularly identified as “Front Passenger Window”) is shown on the screen 5. The operator 23 selects a region of glass panel 1 that he wishes to darken by contacting/sliding the finger over the region of the image representative of the glass panel 22 to be darkened (or lightened) as shown by arrow 24. The operator can change various areas of the screen by rubbing his finger over the region of interest as shown by arrow 25. With the present invention, the operator can, for example, darken various areas of the glass panel 1 without restriction. For example, the operator can even scribble on the touch screen the word “Just Married”, and a selected glass panel 1 will have a tinting in the shape of the word “Just Married”. In some embodiments, the scribble, e.g., the word “Just Married”, is formed by the darkening of the individually selected panel sections 2 (See FIG. 8). From the screen as shown in 6B, the operator can return to the screen shown in 6A by touching the part of the touch screen in 6B that is not the image representative of a glass panel 22.

Referring to FIG. 6C, an exemplary set up of components and algorithm may be as follows: The process of darkening or lightening a glass panel in an automobile is begun as shown in Block 30. A master controller including a microprocessor, digital to analog converter, memory, cabling and access to power is provided as shown in Block 40. A touch sensitive screen in communication with the controller is provided as shown in Block 50. Glass panels including liquid crystal regions and associated touch sensitive sensors adapted to darken and lighten panel sections of a window in coordination with the controller are provided as shown in Block 60. A user is enabled to darken or lighten a glass panel 1, or glass panel section therein, selected from a plurality of glass panels 1, using at least one of the touch sensitive screen, switch means 7 (e.g., variable switch) or touch sensitive sensors associated with the window as shown in Block 70. Once glass panel darkening/lightening is accomplished as desired by a user, the settings can be stored in memory and the process can terminated as shown in Block 80.

One of ordinary skill in the art can employ common technology to implement the above algorithm of activating and deactivating the darkening of a window. Touch sensitive panel and user interfaces are known in the art and are used to display information and provide user control. Examples of touch screen controllers include heating and air conditioning system controllers and personal digital assistants (PDAs). See, for example, U.S. Pat. No. 7,219,990, U.S. Pat. No. 7,228,187, U.S. Pat. No. 7,225,054, U.S. Pat. No. 6,943,778, U.S. Pat. No. 7,158,678, and U.S. Pat. No. 6,769,036, the disclosures of which are incorporated in their entirety by reference herein.

Referring again to FIG. 6A, even though a touch sensitive screen is provided for the convenience of the driver, it may still be desirable to enable passengers to control their glass panel independently. For this reason, a switch means 7, e.g., a manual variable switch (e.g., S¹-S⁴), can be provided that will bypass the touch screen in the user interface 5 or coordinate darkness setting with the touch screen in the user interface 5, as shown in FIG. 1B. Settings from either touch sensitive screen of the user interface 5 or a switch means 7, e.g., a manual variable switch 5′, can be stored within memory 10 so the settings are maintained, or can be stored for later recall.

The present invention also features a system for shading a window, i.e., glass panel 1, with a color shade. One of ordinary skill can employ a color liquid crystal display (LCD) screen that is currently in use on many computers to create a glass panel 1 of the present invention. In some embodiments, the glass panel 1 comprises panel sections 2, wherein the panel sections 2 further comprise tinted panel sub-sections 3. In some embodiments, the panel section 2 comprises at least three tinted panel sub-section 3, wherein each tinted panel sub-section has one of the three primary colors 22 (red, green and blue), as shown FIG. 7. As light shines through these color tinted panel sub-sections 3, they each transform light into the tinted color. For example, when ambient light from outside the car passes through a red tinted panel sub-section 3, the operator inside the car will see the red light. When ambient light from outside the car passes through all the red tinted panel sub-section 3, green tinted panel sub-section 3 and blue tinted panel sub-section 3 equally, the operator inside the car will see the clear “normal,” “non-colored” light.

The relative degree and mixture of red, green and/or blue light that goes through the tinted panel sub-section 3 from the outside of the car will yield a particular final color light that the operator will see from inside the car. As one of ordinary skill would know, a particular amount and blend (e.g., ratio) of red, green and/or blue light transmitting through the respective panel sub-sections 3 would result in a particular color observed by the operator from inside the car. The degree of a light color that is allowed to transmit through a tinted panel sub-section 3 and contribute to the final color is set by the current running to each tinted panel sub-section 3. For example, a current can be applied to the blue tinted panel sub-section 3 to completely prevent light from going through. As a result, only the red and green tinted panel sub-section 3 allows light through. The mixture of red and green light yields a yellow light, and the operator from inside the car will observe the yellow light, and the window will appear to be darkened with a yellow tint. It should now be appreciated that a glass panel incorporating color adjustment can be controlled with a touch panel as described with respect to the embodiment described in FIGS. 6A and 6B.

It should now be appreciated that the window systems of the present invention can also be adapted to a sunroof of a car.

Further, it should now be appreciated that the window systems of the present invention can also be adapted for use in buildings as a window shading mechanism instead of blinds, and for use on any type of protective lenses used for work or recreation (e.g., motorcycle helmets, bike, etc).

Various modifications of the invention, in addition to those described herein, will be apparent to those skilled in the art from the foregoing description. Such modifications are also intended to fall within the scope of the appended claims. Each reference cited in the present application is incorporated herein by reference in its entirety. Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. A window darkening system comprising:
a glass panel which comprises a plurality of panel sections, each panel section comprises at least one layer of liquid crystals sandwiched therein; and
a control module comprising a user interface, said control module activates selectively and independently the at least one layer of liquid crystals in said each panel section to darken one or more selected panel sections.

2. The method of claim 1 wherein the user interface comprises a touch screen.

3. The method of claim 2 wherein the user interface comprises a touch screen showing an image representative of the glass panel,
wherein the control module responsive to a user's touch darkens the at least one layer of liquid crystals corresponding to a touched region on the touch screen.

4. The method of claim 1 wherein the panel section comprises a first, a second and a third panel sub-section,
wherein the first panel sub-section is tinted red, the second panel sub-section is tinted green, and the third panel sub-section is tinted blue,
and wherein the at least one layer of liquid crystal is independently activated in each panel sub-section to allow for various ratios of red light, green light and blue light to pass through each panel section.
